(19) United States
(12) Patent Application Publication
(10) Pub. No.: US 2013/0208952 A1
(43) Pub. Date: Aug. 15, 2013

(54) Method and Apparatus for Improving Accuracy of Biometric Identification in Specimen Collection Applications

(71) Applicant: Geoffrey Auchinleck, Vancouver (CA)

(72) Inventor: Geoffrey Auchinleck, Vancouver (CA)

(21) Appl. No.: 13/371,632

(22) Filed: Feb. 13, 2012

(51) Int. Cl. G06K 9/62

(52) U.S. Cl. 382/115

(57) ABSTRACT

Method and apparatus for using geographical location information to narrow a selection list of persons to be identified by biometric means, thereby improving the accuracy of the biometric identification. The method includes the steps of capturing and storing biometric information about a person, and capturing and storing the person's geographical location. At a later encounter where positive identification of the person is required, biometric information is captured from the person and this biometric information is used to select the best match among biometric information captured for people within a pre-set geographical range of the current location.

### FIELD OF THE INVENTION

The present invention relates generally to the field of electronic biometric identification, and more particularly to ensuring positive identification of patients from whom blood is to be drawn. The invention teaches the use of geographical location information to reduce the likelihood of mis-identification of patients at the time blood samples are drawn.

### BACKGROUND OF THE INVENTION

Blood and other specimen testing is a source of a large portion of the clinical data used by physicians in the diagnosis and treatment of disease. Collection of the required specimens is a critical step in this process, as an incorrectly collected or identified specimen, particularly a specimen that is linked to the wrong patient identification information, is at best useless and at worst, dangerous.

To reduce the likelihood of such errors, generally known as ‘Wrong Blood In Tube’ (WBIT) errors, those collecting blood samples are trained in various procedures designed to reduce the risk. This may include such steps as asking the patient to state their name and date of birth and comparing this to another source of information; pre-printing labels for the specimen containers to ensure accurate, complete and legible information; using bar-coded patient identification wristbands; and having two practitioners cross-check the patient information at the time of collection. These safety procedures work reasonably well in controlled environments such as hospitals, but break down in less controlled environments.

Examples of bedside specimen collection systems are well known in the art. Virtually all of them use some form of bar-coded patient identification wristbands. Examples include the PDC bedside specimen collection system (Precision Dynamics Corporation), the Bridge system (Cerner Inc.) the specimen collection system offered by Siemens and others.

A rapidly aging population in the western world is creating a new challenge for accurate patient identification during specimen collection. The aged are much more likely to be treated in a home or assisted living environment than a hospital, largely because it is prohibitively expensive to admit this growing population into acute care hospitals. Therefore, more and more specimens are being collected in a less-controlled environment. Furthermore, many older patients suffer from dementia, and cannot be trusted to correctly respond when challenged to state their name, birth date or other identifying information. Compounding the problem is the natural unwillingness of older people living independently or assisted to wear an identification tag at all times.

Therefore there is a growing need for a way to positively identify a person that does not rely on that person correctly identifying themselves, does not require them to wear and identifying tag, and can be used in the person's home.

An obvious solution to this problem is to use one of various forms of biometric identification know in the art, such as fingerprinting, iris scanning, facial recognition, palm reading, retinal scanning or others. Although all of these techniques can be made to work, they have not been widely adopted due to cost of the required hardware, bulk, and lack of portability of systems providing sufficiently high identification accuracy. Smaller, mobile versions of such technology often do not provide the speed and accuracy required, or suffer from other impediments to acceptance, such as the reluctance of people to be fingerprinted due to the association with criminal investigations.

Therefore, an ideal specimen collection system will provide for highly accurate identification of the patient though biometric means, without the need for bulky, expensive hardware and will provide for printing of durable, legible and accurate labels at the point of specimen collection (eliminating the risk of pre-printed label mix ups)

Recent developments in mobile technology have resulted in highly portable mobile computing devices (tablet computers and smart phones) that include high-function digital cameras, geographical location devices, computer network connections and powerful processors. This enables a new approach to mobile positive patient identification and specimen collection.

The object of the current invention is to use image-based, non-contact biometric identification on a mobile computing device, linked to a portable specimen label printer to provide a complete specimen collection system that ensures very high accuracy of patient identification.

The invention uses images captured by the camera embedded in a mobile computing device to perform facial recognition (or, in an alternate embodiment, iris recognition). To improve the accuracy of the facial recognition, the patient image to be identified is compared only to registered data for patients known to be within a certain geographical distance from the mobile computing device at the time the identification is to be made, as determined by the geographical location device included in the computing device. Using the geographical information allows the list of identification candidates to be greatly reduced, significantly improving the recognition accuracy.

Upon accurately identifying the patient, the specimen collection system uses the mobile computing device's wired or wireless communications capability to transmit the registered patient identification information to a portable label printer which produces a specimen label.

The invention meets the requirements of mobile, high-accuracy patient identification and on-demand label printing at an uncontrolled patient location, without the need for the patient to self-identify, wear an identity tag or provide finger or palm-prints.

### BRIEF DESCRIPTION OF THE DRAWINGS

The features and advantages of the present invention will become apparent upon reference to the following detailed description of the preferred embodiments and to the drawings, wherein

FIG. 1 is a schematic representation of select components of the specimen collection system according to the present invention.

FIG. 2 is a flow chart showing operational steps used in an illustrated embodiment of a specimen collection system according to the present invention.

FIG. 3 is a flow chart showing the operational steps shows used in an illustrated embodiment of a specimen collection system according to the present invention that are required to register a patient not previously known to the system.

### DETAILED DESCRIPTION OF THE PREFERRED EMBODIMENT

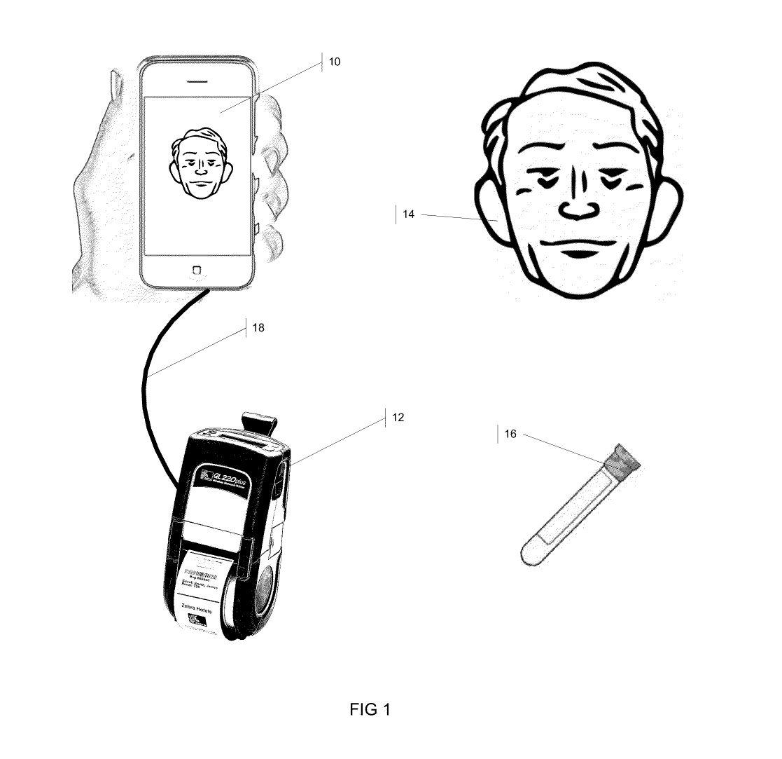

Referring to FIG. 1, mobile computer 10 is a smartphone or tablet computer comprising a computer processor, touch screen display, wireless data communications device, imaging (camera) device and global positioning system device (GPS), which in the preferred embodiment is an iPhone or iPad (Apple Computer Corporation, Cupertino California) running software hereinafter described. Printer 12 is a battery-powered mobile label printer that supports wireless data communications. In the preferred embodiment printer 12 is a model QL-220 printer from Zebra Technologies Inc. (Lincolnshire Ill.), which may be connected to mobile computer 10 with either wired, universal serial bus (USB) connection 18 or a wireless (e.g., Bluetooth) connection.

Patient 14 is a patient from whom specimens are required, usually in the form of blood, but possibly other body fluids. Container 16 is a container suitable for the desired specimen, usually an evacuated test tube for extraction of a blood sample, such as a Vacutainer manufactured by Becton Dickinson Inc. of Franklin Hills New Jersey. The overall objective of the system is to print a label with printer 12 for attachment to container 16 that includes complete, accurate, legible identification information about patient 12.

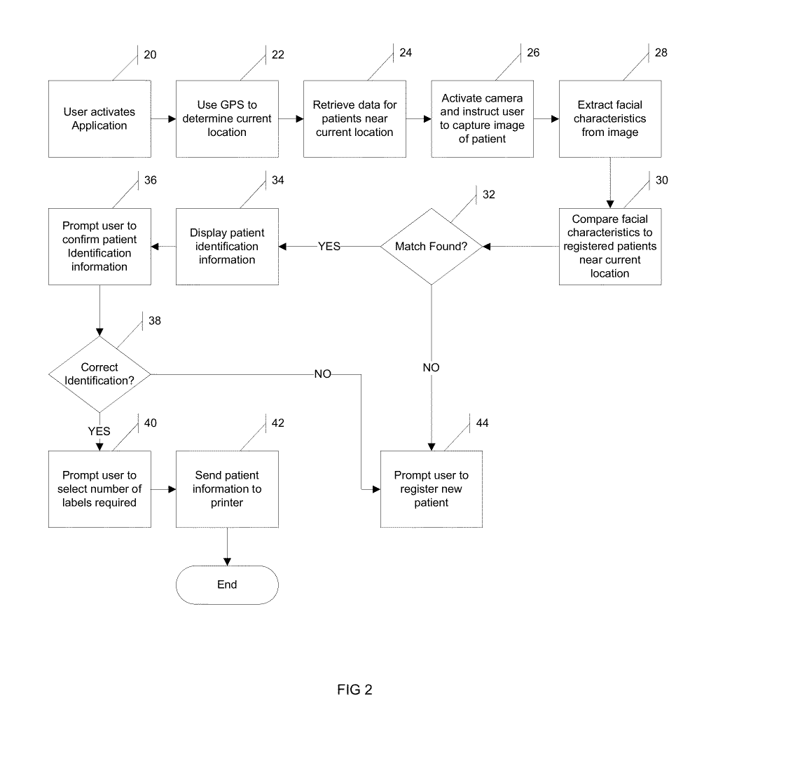

FIG. 2 shows the steps that a phlebotomist or other technician follows when using the specimen collection system.

Preliminarily, a data store containing biometric identification information for plural patients is created (as detailed below). The data store contains biometric identification information for plural patients who have already been identified and whose information has been saved in the data store. The biometric identification information for each such patient is contained in a data record in the data store and each data record in the data store includes patient identifying information including, among other data, name, date of birth, health record number, social security number, etc., and facial identifying characteristics and geographic location information. Patients who have had biometric identification information stored in data records in the data store become “registered” or “recognized” patients or “candidates.” The data store may be within mobile computer 10, or may be a remote data store located on a file server, in which case mobile computer 10 will use one of its wireless network devices (which may include, for example, WiFi, Bluetooth or Cellular Data) to establish a connection to the data store and retrieve the required subset of patient data.

Upon receiving an order to collect specimens, the phlebotomist moves to the expected location of the patient (the patient's home, care facility or assisted living location for example). At the patient's location, the phlebotomist activates the sample collection software application on mobile computer 10 (step 20). This causes the Global Positioning System receiver within mobile computer 10 to determine the current geographical location of mobile computer 10 (step 22). Once the location of mobile computer 10 is known, the software retrieves data from a data store for all patients known to be within a pre-determined geographical distance from the determined location (step 24). The actual geographic distance for the pre-determined distance from the determined location may depend upon the particular circumstances and is variable depending upon the situation at hand. Once the patient data is retrieved, the software causes mobile computer 10 to display a prompt asking the phlebotomist to capture an image of the patient and activates the camera within mobile computer 10 (step 26).

When an image of the patient is captured, the software on mobile computer 10 extracts identifying characteristics from the image using a face recognition algorithm, which in the preferred embodiment is that provided within iOS5 operating system of mobile computer 10 (Apple Computer Corporation, Cupertino Calif.) (step 28). These characteristics are compared to the characteristics in the data set retrieved in step 24 to see if there is a sufficiently good match between the characteristics of the newly captured image and those for one of the previously registered patients—the “registered recognition candidates” (step 30). If no sufficiently good match is found, the software on mobile computer 10 prompts the phlebotomist to register the image from the unidentified patient as being for a new patient, following the process hereinafter described (step 46). A patient whose identifying characteristics have not yet been saved in a data record in the data store is referred to at times herein as an “unidentified” recognition candidate or patient.

If a suitable match is found (step 32) the associated patient demographic information is displayed on the screen of mobile computer 10 (step 34), after which the phlebotomist is prompted to confirm that the displayed patient identification is correct (step 36). If the phlebotomist indicates that the patient information is not correct (step 38), the software on mobile computer 10 prompts the phlebotomist to register the image as being for a new patient, following the process hereinafter described (step 46). Secondary confirmation of patient identity may also be conducted using personal identifying information such as name, address, health record number, social security number, etc.

If the phlebotomist indicates that the correct patient identification is displayed, they are prompted to collect the required specimens (step 40). Once the phlebotomist indicates that the specimen collection is complete, they are prompted to select the number of specimen labels required (step 42). This causes mobile computer 10 to send data to mobile printer 12 over serial connection 18 to cause the correct number of labels to print (step 44).

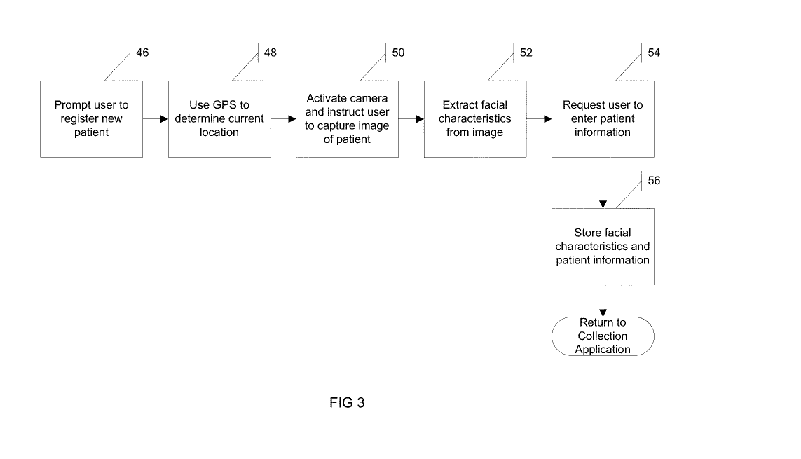

FIG. 3 shows the steps required to register a patient not previously known to the system. If a new registration is required (step 46), mobile computer 10 uses its internal GPS location device to capture the current location of the patient (step 48) then activates the camera device within mobile computer 10 and prompts the phlebotomist to capture an image of the patient's face (step 50). In the preferred embodiment, guide lines are superimposed on the live camera image to suggest the placement of the patient's face and how close the camera should be.

Once an image is captured, the software on mobile computer 10 extracts the facial feature data from the image (step 52). The phlebotomist is then prompted to enter the patient's identification information (e.g. name, date of birth, health record number, etc.) (step 54). Once all the required data is entered, the patient information, facial characteristics data and GPS location data are transferred to the data store (step 56) and the software on mobile computer 10 returns to the specimen collection process previously described.

In practice, the current invention ensures that specimen label information correctly refers to the patient from which the specimen is drawn. The current invention improves upon the prior art in that biometric means are used to identify the patient, but the biometric identification accuracy is greatly enhanced by using geographic location information to reduce the number of identification candidates. Further, unlike other biometric identification means, a facial image capture requires no contact with the patient's body and can be done with apparatus already embedded in commonly available mobile computing devices.

Many different adaptations and variations of the subject invention are possible without departing from the scope and spirit of the present invention; therefore, the present invention should be limited only by the scope of the appended claims. For example, although the preferred embodiment uses facial recognition as the biometric identification means, a similar result could be achieved with iris recognition, fingerprint, palm, or other biometric recognition means. Further, although the preferred embodiment uses iOS5-based products such as the iPhone and iPad from Apple Computer Corporation, there are many suitable tablet computer and smartphone devices that could perform the same function. Similarly, numerous companies provide commercially-available face recognition algorithms that could be used instead of those provided by Apple Computer Corporation. Finally, the software systems may be provided in a variety of platforms such as, for example, use of the software as a service platform.

I claim:

1. A method for improving the accuracy of biometric recognition comprising the steps of:
(a) at a first encounter, registering a registered recognition candidate by:
i) capturing biometric information about the registered recognition candidate;
ii) recording the biometric identification information about the registered recognition candidate;
iii) determining the registered recognition candidate's geographical location; and
iv) creating and storing a data record for the registered recognition candidate comprising the biometric information, geographical location and identification information;
(b) creating a data store containing plural data records for plural registered recognition candidates, each data record in the data store comprising biometric information, geographical location and identification information
(c) at a subsequent encounter, identifying an unidentified recognition candidate by:
i) capturing biometric information about the unidentified recognition candidate;
ii) determining the unidentified recognition candidate's geographical location;
(d) selecting from the data store only those data records including geographical locations within a pre-determined geographical distance from the unidentified recognition candidate's geographical location;
(e) comparing the biometric information about the unidentified recognition candidate with the biometric information for registered recognition candidates in the data records selected in step (d); and
(e) providing the identification information from the data record having the best match between the unidentified recognition candidate's biometric information and the data store's biometric information.

2. The method according to claim 1 in which the step of capturing biometric information about the registered recognition candidate includes capturing an image of the registered recognition candidate.

3. The method according to claim 2 in which the step of capturing biometric information about the unidentified recognition candidate includes capturing an image of the unidentified recognition candidate.

4. The method according to claim 3 in which the comparison in step (d) includes comparing the image of the unidentified recognition candidate with images of registered recognition candidates contained in the selected data records.

5. The method according to claim 4 including determining whether a match is established between the unidentified recognition candidate and a registered recognition candidate.

6. The method according to claim 5 in which if a match is established, including the step of printing a label containing identifying information.

7. The method according to claim 5 in which if no match is established, including the step of adding biometric information about the unidentified recognition candidate to said data store so that the biometric information for the unrecognized recognition candidate is stored in a data record in the data store and the unrecognized recognition candidate thereby becomes a registered recognition candidate.

8. A method for improving the accuracy of biometric recognition comprising the steps of:
(a) registering plural recognized candidates in a data store by, at a first encounter with each individual recognition candidate in the plurality:
i) capturing an image of the recognized candidate;
ii) extracting facial information about the recognized candidate from the captured image;
iii) recording identification information about the recognized candidate;
iv) determining the recognized candidate's geographical location; and
v) creating and storing a biometric information data record for each recognized candidate, each data record comprising the facial information, geographical location and identification information for said recognized candidates;
(b) at a subsequent encounter, identifying an unidentified candidate by:
i) capturing an image of the unidentified candidate;
ii) extracting facial information about the unidentified candidate from the captured image;
iii) determining the unidentified candidate's geographical location;
iv) selecting from biometric information previously stored in the data store only those data records that include geographical locations for recognized candidates within a pre-determined geographical distance from the unidentified candidate's geographical location;
(v) comparing the facial information about the unidentified candidate with the facial information in each of the selected biometric information data records; and
(c) providing the biometric information data from the biometric information data record having the best match between the unidentified candidate's facial information and the biometric information data record's facial information.

9. The method according to claim 8 further including the steps of including the image of the recognized candidates captured at the first encounter in the data store and providing the image from the data record having the best match between a recognized candidate's facial information from the data store and the facial information about the unidentified candidate from the captured image.

10. The method according to claim 8 including determining whether a match is established between the recognized candidate encountered at said subsequent encounter and a recognized candidate.

11. The method according to claim 10 in which if a match is established, including the step of printing a label containing recognition candidate identifying information.

12. The method according to claim 10 in which if no match is established, including the step of adding biometric information about the unidentified candidate to said data store.

13. A method for improving the accuracy of biometric recognition comprising the steps of:
a) creating biometric identification for an unidentified candidate by:
i) capturing an image of the unidentified candidate;
ii) extracting facial information about the unidentified candidate from the captured image;
iii) determining the unidentified candidate's geographical location; and
iv) creating a data record containing biometric identifying information comprising at least the extracted facial information and geographical location information for the unidentified candidate;
(b) comparing the data record for said unidentified candidate with previously created data records for plural recognized candidates stored in a data store, each data record in the data store containing biometric identifying information comprising at least facial information and geographical location information for a recognized candidate; and
(c) identifying the data record from the data store that contains biometric identifying information that most closely matches the data record for the unidentified candidate.

14. The method according to claim 13 including the step of selecting for comparison in step (b) only those data records from the data store that include geographical location information within a pre-determined distance from the unidentified candidate's geographical location.

15. The method according to claim 14 wherein the comparison in step (b) further comprises comparing facial information about the unidentified candidate with facial information for the selected data records.

16. The method according to claim 15 wherein each data record in the data store includes personal identifying information for the recognized candidates, said personal identifying information including at least the recognized candidate's name.

17. The method according to claim 16 wherein the step of creating biometric identification for an unidentified candidate includes obtaining personal identifying information including at least the unidentified candidate's name.

18. The method according to claim 17 wherein step (b) further comprises comparing said unidentified candidate's personal identifying information with the personal identifying information for each of said selected data records.

19. The method according to claim 18 including determining whether a match is established between the unidentified candidate and a recognized candidate.

20. The method according to claim 19 in which if a match is established, including the step of printing a label containing personal identifying information.

21. A method for improving the accuracy of biometric recognition comprising the steps of:
a)
i) capturing biometric information about an unidentified candidate;
iii) determining the unidentified candidate's geographical location; and
iv) creating a data record containing biometric identifying information comprising at least the biometric information and geographical location information for the unidentified candidate;
(b) comparing the data record for said unidentified candidate with previously created data records for plural recognized candidates stored in a data store, each data record in the data store containing at least biometric identifying information and geographical location information for a recognized candidate; and
(c) identifying the data record from the data store that contains biometric identifying information that most closely matches the data record for the unidentified candidate.
